(19) United States
(12) Patent Application Publication
(10) Pub. No.: US 2025/0028114 A1
(43) Pub. Date: Jan. 23, 2025

(54) INTEGRATED LENS IN LASER MICRO PACKAGE THROUGH WAFER FABRICATION

(71) Applicant: Cisco Technology, Inc., San Jose, CA (US)

(72) Inventors: Xunyuan ZHANG, Mechanicsburg, PA (US); Weizhuo LI, Berkeley Heights, NJ (US); Steven H. HOVEY, Goleta, CA (US); Michael P. MACK, San Diego, CA (US); Steffen GLOECKNER, San Diego, CA (US)

(21) Appl. No.: 18/353,760

(22) Filed: Jul. 17, 2023

(51) Int. Cl. G02B 6/12

(52) U.S. Cl. CPC G02B 6/12004; G02B 2006/12061; G02B 2006/12085; G02B 2006/12102; G02B 2006/12104; G02B 2006/12107; G02B 2006/12116; G02B 2006/12121; G02B 2006/12166

(57) ABSTRACT

Embodiments herein describe optical devices that include focusing elements in or on a substrate on which a laser source is disposed. That is, the focusing element can be arranged on a same surface of the substrate as the laser source. In one embodiment, the laser source emits an optical signal that is parallel with the same surface of the substrate. A turning mirror can be used to direct the optical signal in a direction perpendicular to the surface so that the optical signal is incident on the focusing element.

### TECHNICAL FIELD

Embodiments presented in this disclosure generally relate to using lens integrated in or on a substrate for an optical source.

### BACKGROUND

Optical communication has revolutionized how information is transmitted. Mass-produced semiconductor lasers transmit multiple-wavelength optical signals over low-loss, low-dispersion optical fibers, modulated at multi-gigabit per second (GB/s) rates, for hundreds of kilometers. Text, voice, audio, and video data are transmitted around the globe utilizing optical fibers, supporting both wired and wireless communication systems.

Optical fiber communication has moved into lower cost, yet still high performance applications, such as metro access networks and enterprise LAN backbones. Single-mode fiber (SMF) is poised to replace short copper links in high data rate, 10 GB/s and above, applications.

As data networks scale to meet ever-increasing bandwidth requirements, the shortcomings of copper data channels are becoming apparent. Signal attenuation and crosstalk due to radiated electromagnetic energy are the main impediments encountered by designers of such systems. They can be mitigated to some extent with equalization, coding, and shielding, but these techniques require considerable power, complexity, and cable bulk penalties while offering only modest improvements in reach and very limited scalability. Free of such channel limitations, optical communication has been recognized as the successor to copper links.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 is a schematic of an optical device including a laser, an integrated lens, and a turning mirror incorporated in a hermetically sealed package, according to one embodiment described herein.

FIG. 2 is a schematic of an optical device including a laser, a metalens, and a turning mirror incorporated in a hermetically sealed package, according to one embodiment described herein.

FIG. 3 is a flowchart for assembling an optical device, according to one embodiment described herein.

FIGS. 4A-4D illustrate assembling an optical device with an integrated lens, according to embodiments described herein.

FIGS. 5A-5D illustrate assembling an optical device with a metalens, according to embodiments described herein.

FIG. 6 illustrates a metalens, according to one embodiment described herein.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes processing a semiconductor substrate to include a focusing element at a first surface of the semiconductor substrate, disposing a laser source on the first surface after the focusing element has been added to the semiconductor substrate, and hermetically sealing the laser source and the focusing element using a lid, wherein the lid comprises a turning mirror that is arranged to receive an optical signal from the laser source and reflect the optical signal to the focusing element, wherein the optical signal passes through the focusing element and the substrate.

Another embodiment presented in this disclosure is an optical device that includes a substrate comprising a metalens disposed on a first surface of the substrate, a laser source disposed on the first surface, and a lid hermetically sealing the laser source and the metalens where the lid includes a turning mirror arranged to receive an optical signal from the laser source and reflect the optical signal to the metalens and where the optical signal passes through the metalens and the substrate.

Another embodiment presented in this disclosure is an optical device that includes a substrate comprising a focusing element disposed on a first surface of the substrate, a laser source disposed on the first surface, a lid hermetically sealing the laser source and the focusing element where the lid includes a turning mirror arranged to receive an optical signal from the laser source and reflect the optical signal to the focusing element where the optical signal passes through the focusing element and the substrate, and a quarter-wave plate on a second surface of the substrate, and where the second surface is opposite the first surface, and where the optical signal is configured to pass through the quarter-wave plate after passing through the substrate.

### Example Embodiments

Embodiments herein describe optical devices that include focusing elements in or on a substrate on which a laser source is disposed. That is, the focusing element can be arranged on a same surface of the substrate as the laser source. In one embodiment, the laser source emits an optical signal that is parallel with the surface of the substrate. A turning mirror can be used to direct the optical signal in a direction perpendicular to the surface so that the optical signal is incident on the focusing element.

After passing through the focusing element, the optical signal also passes through the substrate before exiting the optical device. The optical device can be aligned to a photonic chip with an optical interface (e.g., a grating coupler) on a top surface so that the optical signal is received at the optical interface. In this manner, the optical device can be a light source for introducing an optical signal into the photonic chip.

In one embodiment, the focusing element is a lens that is integrated into the substrate. For example, the lens may be a silicon lens that is formed as part of fabricating a silicon wafer that will form the substrate. One advantage of using a lens that is integrated into the substrate is that precise semiconductor fabrication etching techniques can be used to form the lens on the substrate.

In another embodiment, the focusing element is a metalens that is disposed on the substrate. The metalens can be fabricated in parallel with fabricating the substrate. For example, the metalens can be produced using existing CMOS semiconductor techniques. One advantage of using the metalens to focus an optical signal received from the laser source is that again precise semiconductor fabrication etching techniques can be used to form the metalens on the substrate.

In one embodiment, the substrate includes a quarter-wave plate disposed on a surface of the substrate that is opposite the surface on which the focusing element and the laser source are disposed. The quarter-wave plate may be added to the substrate depending on a type of grating used to introduce the optical signal into the photonic chip. A 45 degree rotated grating coupler has much lower specular reflection than a grating coupler that is not 45 degree rotated. The quarter-wave plate makes the optical device compatible with the lower reflection of the 45 degree rotated grating coupler. As such, the quarter-wave plate may be used, or omitted, depending on the type of grating coupler used in the photonic chip.

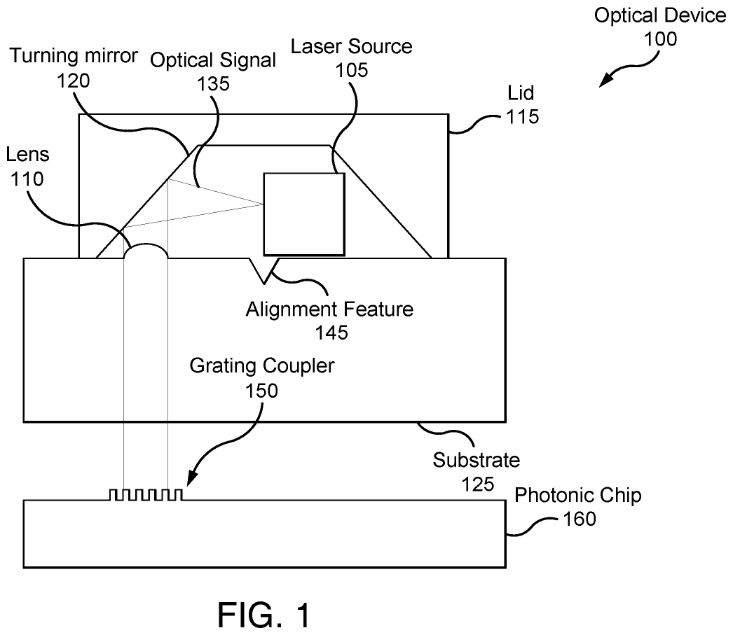

FIG. 1 is a schematic of an optical device 100 including a laser source 105, a lens 110, and a turning mirror 120 incorporated in a hermetically sealed package, according to one embodiment described herein. As shown, the optical device 100 includes a lid 115 and a substrate 125. In one embodiment, the lid 115 and the substrate 125 are respective semiconductor wafers (e.g., silicon wafers) that are bonded together to form the hermetically sealed package that includes the laser source 105 and the lens 110.

The laser source 105 emits an optical signal 135 (e.g., a continuous wave) in the direction of a turning mirror 120. In this example, the optical signal 135 travels in a direction substantially parallel to the top surface of the substrate 125 when propagating between the laser source 105 and the turning mirror 120. The optical signal 135 is reflected by the turning mirror 120 formed in one of the sides of the lid 115. The turning mirror 120 reflects the optical signal 135 down through the lens 110 and through the substrate 125. That is, the turning mirror 120 causes the optical signal 135 to then propagate in a direction that is substantially perpendicular to the top surface of the substrate 125. As used herein, “substantially” perpendicular or parallel means the direction of propagating can be with +/−20 degrees of being perfectly perpendicular or parallel with the top surface. For example, when reflecting the optical signal 135, the turning mirror 120 may direct the optical signal 135 in a direction that is not perfectly perpendicular to the top surface but is within 20 degrees from being perpendicular to the top surface.

The lens 110 and substrate 125 can be formed from a material that is transparent to the optical signal 135. The optical device 100 can be bonded or coupled to a photonic chip 160 that includes an optical interface (e.g., a grating coupler 150) that aligns with the optical signal 135 after passing through the substrate 125. In this manner, an optical signal 135 generated by the laser source 105 can be introduced into a waveguide in the photonic chip 160.

In this embodiment, the lens 110 is integrated into the substrate 125. For example, the lens 110 may be a silicon lens that is formed as part of fabricating a silicon wafer that will form the substrate 125. One advantage of using the integrated lens 110 to focus an optical signal 135 received from the laser source 105 is that precise semiconductor fabrication etching techniques can be used to form the lens 110 on the substrate 125. In one embodiment, the lens 110 has a focal point that is at, or near (e.g., within −/+10 microns) the grating coupler 150.

The optical device 100 (or the photonic chip 160 to which it is coupled) can generate back reflections resulting from the optical signal 135 being reflected by various surfaces (e.g., the top surface of the photonic chip 160). These back reflections propagate in the opposite direction of the optical signal 135 and eventually reach the laser source 105, which is undesirable. Previous optical devices include a Faraday rotator that rotates these back reflection so their polarization is perpendicular to the laser beam emitted by laser source 105. The Faraday rotator may reduce and/or eliminate optical feedback to the laser source 105 by rotating any reflected optical signal another 45 degrees for a total of 90 degrees from the optical mode emitted by the laser source 105 to reduce and/or eliminate feedback effects. That is, the Faraday rotator first rotates the optical signal 135 45 degrees when it first passes through the rotator and any back reflections are rotated an additional 45 degrees in the same rotational direction for a total of 90 degrees. Light with a 90 degree rotation relative to the optical signal 135 emitted by the laser source 105 has little to no effect on the laser source 105.

However, by integrating the lens 110 into the substrate 125, there may be insufficient room to dispose a Faraday rotator between the laser source 105 and the lens 110. For example, the divergence of the optical signal 135 when emitted by the laser source 105 can be quite large. As such, if the optical distance between the laser source 105 and the lens 110 is increased to make room for a Faraday rotator, the optical signal may diverge too much and some of the optical signal 135 may not be incident on the lens, creating loss. Or the lens 110 may have to be increased in size, which makes the size of the optical device 100 larger. Thus, to facilitate miniaturization and to avoid optical loss, the Faraday rotator is omitted so that the lens 110 can be formed in the substrate, in contrast to other solutions which may use a ball lens that is disposed between the turning mirror 120 and the laser source 105.

Since there is no Faraday rotator, a laser that is insensitive to back reflections could be used as the laser source 105 in which case the Faraday rotator is not needed, although these types of laser source are more expensive. In another embodiment, a Faraday rotator could be disposed in a different location such as between the substrate 125 and the photonic chip 160 but still be in the path of the optical signal 135. That way, a laser source 105 that is sensitive to back reflections could be used.

The light source assembly may be hermetically sealed where the lid 115 is affixed via solder, epoxy, or glass frit to the substrate 125. Hermetic sealing the laser source 105, the lens 110, and the turning mirror 120 may increase device lifetime by reducing or eliminating environmental effects on the optical elements in the assembly.

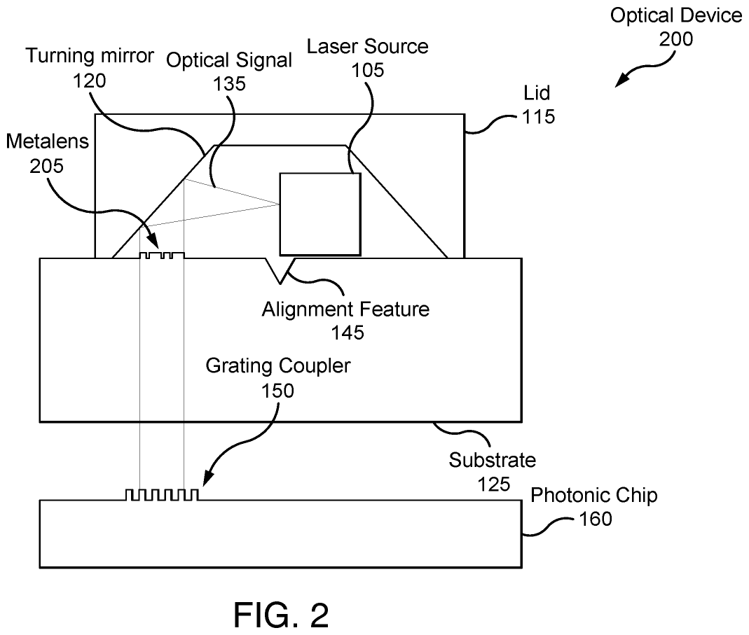

Further, while the embodiments discuss using an integrated lens 110 (e.g., a semiconductor lens fabricated on the substrate 125), other types of lens can be used, which may lead to several advantages. A different lens type is discussed in FIG. 2.

The laser source 105 may be a semiconductor laser diode, for example, and may be coupled epi-side up on a top surface of the substrate 125. The laser source 105 may emit light at a wavelength that corresponds to the appropriate wavelength of light for the optical transceivers integrated in a complementary metal oxide semiconductor (CMOS) chip or an optical fiber cable.

The substrate 125 also includes an alignment feature 145 for the laser source 105. Using the alignment feature 145 and bonding the laser source 105 epi-side down enables accurate height control of the optical signal from the laser source 105 with the turning mirror 120 so that optical signal 135 is incident on the lens 110. In addition, mounting the laser source 105 epi-side down allows for better heat transfer to the large thermal mass of the laser source 105 substrate as well as into the alignment feature 145.

FIG. 2 is a schematic of an optical device 200 including the laser source 105, a metalens 205, and the turning mirror 120 incorporated in a hermetically sealed package, according to one embodiment described herein. The optical device 200 has the same components and arrangement as the optical device 100 in FIG. 1 as indicated by using the same reference numbers as used in FIG. 1. However, the optical device 200 differs from FIG. 1 in that the lens 110 is replaced by the metalens 205.

The metalens 205 can include smaller optical elements that can manipulate light like traditional lenses but with smaller profiles (e.g., smaller heights). Traditional lenses (e.g., the lens 110 in FIG. 1) work by bending light waves. Lenses with different thickness or varying thickness bend the waves in different ways. In contrast, the metalens 205 can be a thin, flat structure with multiple waveguides (e.g., rectangular or cylindrical pillars) arranged in specific patterns. Because metalenses can be flat (planar) and thin, they do not produce chromatic aberrations (i.e., are achromatic) because different wavelengths of light pass through virtually simultaneously. The metalens 205 can also perform tunable dispersion (i.e., the ability to manipulate how colors of light are dispersed) as opposed traditional lenses which have fixed dispersions.

The metalens 205 can be fabricated in parallel with fabricating the substrate 125. For example, the metalens 205 can be produced using existing CMOS semiconductor techniques. One advantage of using the metalens 205 to focus an optical signal 135 received from the laser source 105 is that precise semiconductor fabrication etching techniques can be used to form the metalens 205 on the substrate 125. In one embodiment, the metalens 205 has a focal point that is at, or near (e.g., within −/+10 microns) the grating coupler 150.

Like in FIG. 1, by integrating the metalens 205 into the substrate 125, there may be insufficient room to dispose a Faraday rotator between the laser source 105 and the metalens 205 due to the divergence of the optical signal 135 when emitted by the laser source 105. As such, if the optical distance between the laser source 105 and the metalens 205 is increased to make room for a Faraday rotator, the optical signal may diverge too much and some of the optical signal 135 may not be incident on the metalens 205, creating loss. Or the metalens 205 may have to be increased in size, which makes the size of the optical device 200 larger. Thus, to facilitate miniaturization and to avoid optical loss, the Faraday rotator is omitted so that the metalens 205 can be formed in the substrate in contrast to other solutions which may use a ball lens that is disposed between the turning mirror 120 and the laser source 105.

Since there is no Faraday rotator, a laser that is insensitive to back reflections could be used as the laser source 105 in which case the Faraday rotator is not needed, although these types of laser source are more expensive. In another embodiment, a Faraday rotator could be disposed between the substrate 125 and the photonic chip 160 but still in the path of the optical signal 135. That way, a laser source 105 that is sensitive to back reflections could be used.

Thus, FIGS. 1 and 2 illustrate two different types of lenses that can be disposed on the substrate 125. Advantageously, in one embodiment, these lenses are fabricated by the same CMOS foundry that forms the substrate 125. Different techniques for fabricating and assembling the optical devices 100 and 200 as discussed below.

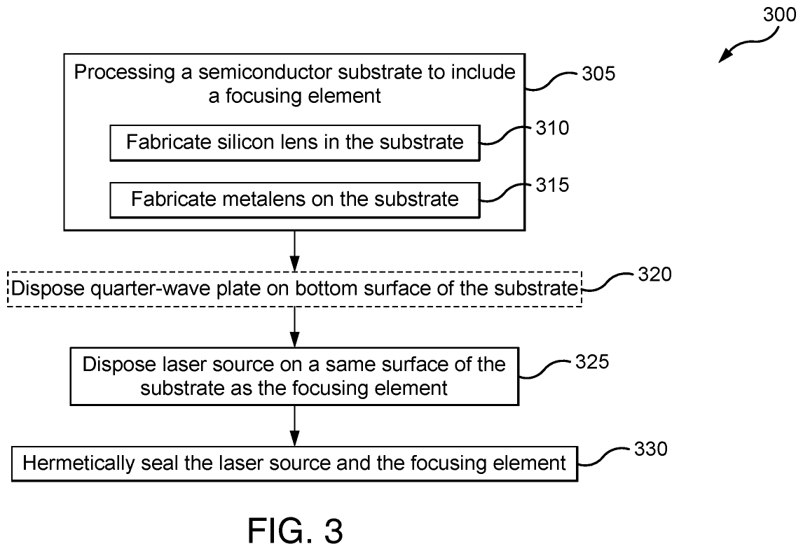

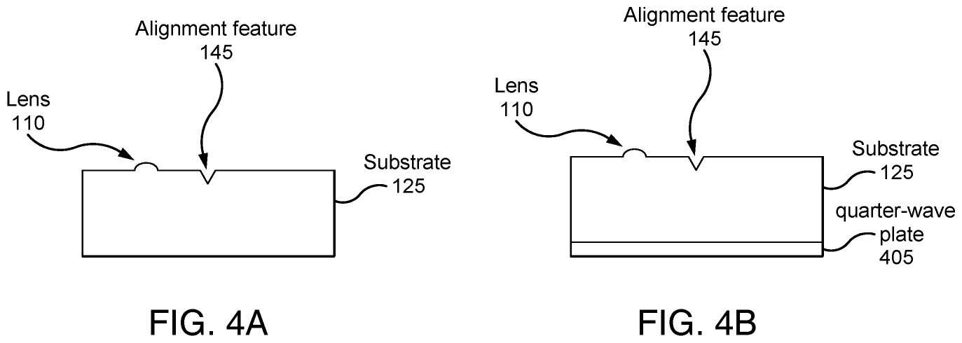

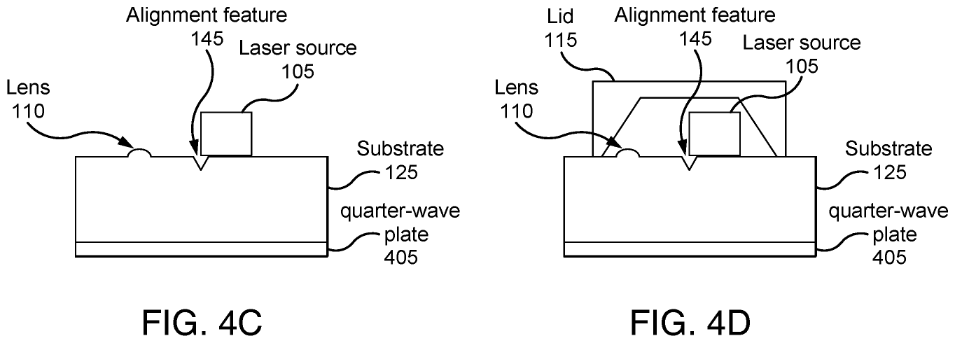

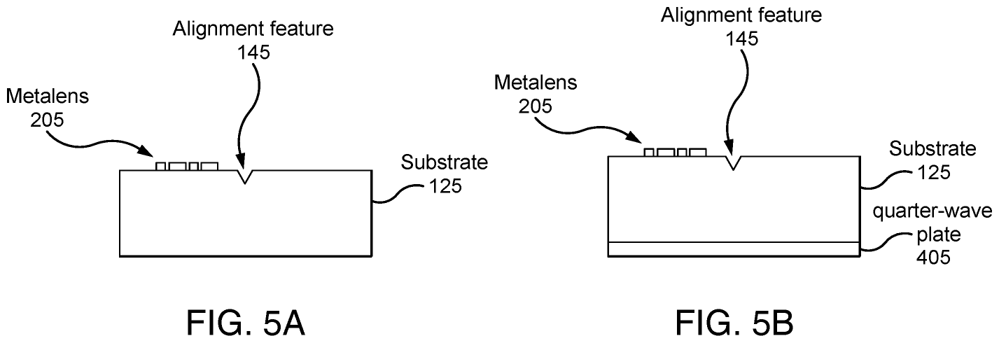

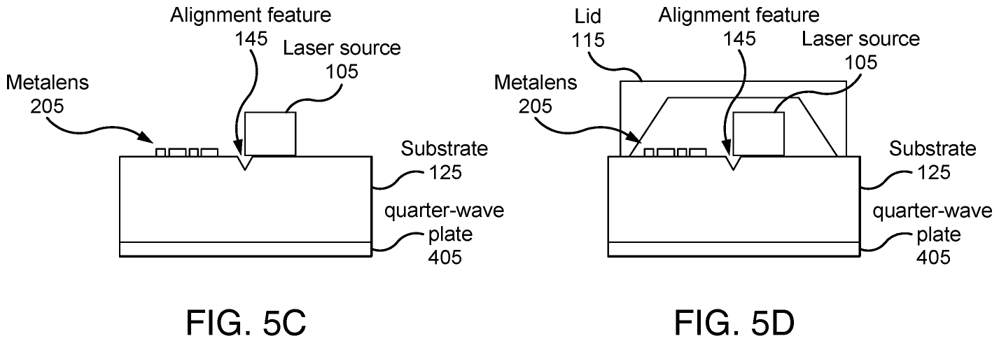

FIG. 3 is a flowchart of a method 300 for assembling an optical device, according to one embodiment described herein. For ease of explanation, the blocks in the method 300 are discuss in tandem with FIGS. 4A-4D which illustrate assembling an optical device with an integrated lens and FIGS. 5A-5D which illustrate assembling an optical device with a metalens, according to one embodiment described herein.

At block 305, a semiconductor substrate is processed to include a focusing element at a first surface of the semiconductor substrate. That is, the focusing element is disposed on or is integrated into the first surface of the semiconductor substrate (e.g., a silicon substrate). As non-limiting examples, the focusing element can include an integrated lens such as lens 110 in FIG. 1 or a metalens such as the metalens 205 in FIG. 2.

At sub-block 310, a silicon lens is fabricated in the substrate. For example, assuming the substrate is formed from a silicon wafer, the wafer can be etched to form the silicon lens. This is shown in FIG. 4A where the lens 110 can be formed in the substrate 125. This can be done using the same CMOS techniques used to form the alignment feature 145. Thus, rather than having to place a focusing lens on the substrate 125 in a later assembly step, the substrate 125 can be fabricated with the silicon lens.

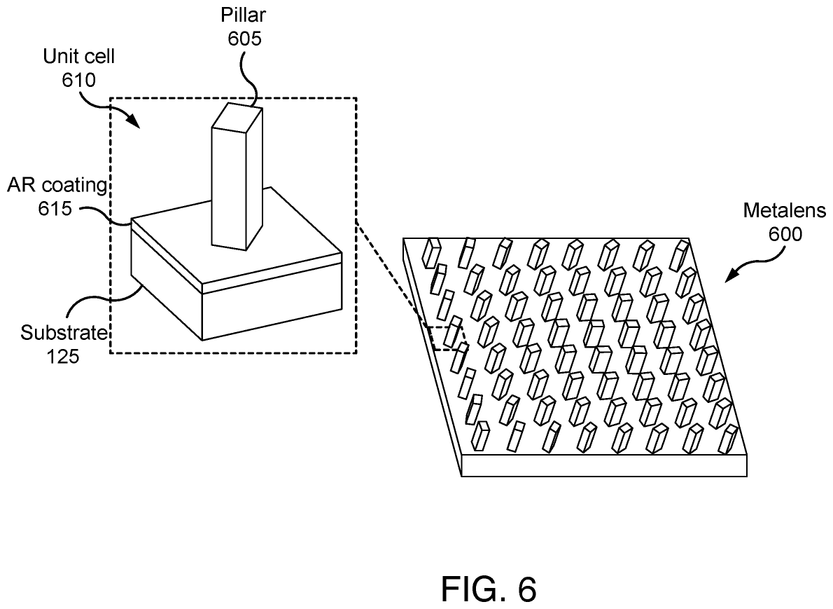

Alternatively, at sub-block 315, a metalens is fabricated on the substrate. For example, a thin film may be deposited on the top surface of the substrate 125. This film can then be etched to form pillars which make up the metalens 205. Forming the metalens 205 will be discussed in more detail in FIG. 6 below.

FIG. 5A illustrates forming the metalens 205 on the top surface of the substrate 125. The pillars forming the metalens 205 may have the same height but different widths and/or orientations. The metalens 205 can be formed on the substrate 125 during the same CMOS fabrication process used to form the alignment feature 145. Thus, rather than having to place a focusing lens on the substrate 125 in a later assembly step, the substrate 125 can be fabricated with the metalens 205.

Returning to the method 300, at block 320 a quarter-wave plate is disposed on a bottom surface of the substrate. Block 320 is shown in dotted lines since it is an optional step in the method 300 and can depend on the type of grating used in the photonic chip.

FIGS. 4B and 5B illustrate disposing a quarter-wave plate 405 on a surface of the substrate 125 that is opposite the surface that has the lens 110 and the metalens 205. Thus, after passing through the lens 110, the metalens 205, and the substrate 125, the optical signal also passes through the quarter-wave plate 405 before reaching the photonic chip (not shown). In one embodiment, the quarter-wave plate 405 is formed by bonding a quartz wafer to the substrate 125 and then grinding the quartz wafer to a desired thickness to serve as a quarter-wave plate.

The quarter-wave plate 405 may be added to the substrate 125 depending on a type of grating used to introduce the optical signal into the photonic chip 160 in FIGS. 1 and 2. A 45 degree rotated grating coupler has much lower specular reflection than a grating coupler that is not 45 degree rotated. The quarter-wave plate 405 makes the optical device compatible with the lower reflection of the 45 degree rotated grating coupler. As such, the quarter-wave plate 405 may be used, or omitted, depending on the type of grating coupler used in the photonic chip 160.

Returning to the method 300, at block 325 a laser source is disposed on a same surface of the substrate as the focusing element. This is illustrated in FIGS. 4C and 5C where the laser source 105 is disposed on the top surface of the substrate 125. In one embodiment, the laser source 105 is aligned to the top surface using the alignment feature 145.

At block 330, the laser source and the focusing element are hermetically sealed. As shown in FIGS. 4D and 5D, the lid 115 is disposed over the lens 110, the metalens 205, and the laser source 105. The lid 115 can be affixed via solder, epoxy, or glass frit to the substrate 125 to create a hermetic seal.

In one embodiment, the optical devices are assembled in a vacuum environment. Thus, after the lid 115 is affixed to the substrate 125, the optical devices 100 can be removed from the vacuum environment and the hermetic seal maintains the vacuum within the volume defined by the lid 115.

FIG. 6 illustrates a metalens 600, according to one embodiment described herein. The metalens 600 includes a plurality of unit cells 610 each containing an individual pillar 605. FIG. 6 includes a blown out view of one of the units cells 610. As shown, an anti-reflective (AR) coating 615 is deposited on the substrate 125. The pillar 605 is formed on the AR coating 615. For example, a thin film of the material used to form the pillars 605 can be deposited on the AR coating 615. This film can then be patterned and etched to form the pillars 605 in each of the unit cells 610.

FIG. 6 illustrates that the pillars 605 have the same height, but can have different orientations (or rotations) relative to each other. That is, the pillars 605 can be rotated around the Z axis. Changing the rotation can change the properties of the metalens 600. In addition to changing the rotation, the pillars 605 can also have different widths (e.g., in the X or Y axis).

The embodiments herein are not limited to any particular type or orientation of the metalens 600 so long as the metalens 600 is able to focus the optical signal 135 onto the grating coupler 150 as shown in FIG. 2.

Although FIG. 6 illustrates a rectangular shaped metalens 600, in other embodiments, the layout of the pillars 605 may be circular. In one embodiment, the metalens 600 has a diameter greater than 150 microns. In one embodiment, the metalens 600 has a diameter between 150-250 microns. In one embodiment, the pillars 605 may have a width in the Y or X directions between 0.05-0.3 microns.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In view of the foregoing, the scope of the present disclosure is determined by the claims that follow.

We claim:

1. A method, comprising:
processing a semiconductor substrate to include a focusing element at a first surface of the semiconductor substrate;
disposing a laser source on the first surface after the focusing element has been added to the semiconductor substrate; and
hermetically sealing the laser source and the focusing element using a lid, wherein the lid comprises a turning mirror that is arranged to receive an optical signal from the laser source and reflect the optical signal to the focusing element, wherein the optical signal passes through the focusing element and the semiconductor substrate.

2. The method of claim 1, wherein processing the semiconductor substrate to include the focusing element comprises:
fabricating a lens in the semiconductor substrate such that the lens is integrated into the semiconductor substrate.

3. The method of claim 2, wherein the lens is a silicon lens and the semiconductor substrate is a silicon substrate.

4. The method of claim 1, wherein processing the semiconductor substrate to include the focusing element comprises:
fabricating a metalens on the semiconductor substrate such that the metalens is formed on the first surface of the semiconductor substrate.

5. The method of claim 4, wherein the metalens comprises a plurality of unit cells with individual pillars, wherein the individual pillars have a same height.

6. The method of claim 1, further comprising:
disposing a quarter-wave plate on a second surface of the semiconductor substrate before disposing the laser source on the first surface, wherein the second surface is opposite the first surface, wherein the optical signal is configured to pass through the quarter-wave plate after passing through the semiconductor substrate.

7. An optical device, comprising:
a substrate comprising a metalens disposed on a first surface of the substrate;
a laser source disposed on the first surface; and
a lid hermetically sealing the laser source and the metalens, wherein the lid comprises a turning mirror arranged to receive an optical signal from the laser source and reflect the optical signal to the metalens, wherein the optical signal passes through the metalens and the substrate.

8. The optical device of claim 7, wherein the metalens comprises a plurality of unit cells with individual pillars, wherein the individual pillars have a same height.

9. The optical device of claim 7, wherein the metalens has a diameter that is greater than 150 microns.

10. The optical device of claim 7, further comprising:
a quarter-wave plate on a second surface of the substrate, wherein the second surface is opposite the first surface, wherein the optical signal is configured to pass through the quarter-wave plate after passing through the substrate.

11. The optical device of claim 10, further comprising:
a photonic chip, wherein the quarter-wave plate is disposed between the photonic chip and the substrate.

12. The optical device of claim 11, wherein the photonic chip comprises a grating coupler, wherein the metalens is configured to focus the optical signal onto the grating coupler.

13. The optical device of claim 12, wherein the optical signal propagates in a direction substantially parallel to the first surface between the laser source and the turning mirror and propagates in a direction substantially perpendicular to the first surface between the turning mirror and the grating coupler.

14. An optical device, comprising:
a substrate comprising a focusing element disposed on a first surface of the substrate;
a laser source disposed on the first surface;
a lid hermetically sealing the laser source and the focusing element, wherein the lid comprises a turning mirror arranged to receive an optical signal from the laser source and reflect the optical signal to the focusing element, wherein the optical signal passes through the focusing element and the substrate; and
a quarter-wave plate on a second surface of the substrate, wherein the second surface is opposite the first surface, wherein the optical signal is configured to pass through the quarter-wave plate after passing through the substrate.

15. The optical device of claim 14, wherein the focusing element is a metalens, wherein the metalens comprises a plurality of unit cells with individual pillars, wherein the individual pillars have a same height, wherein the metalens has a diameter that is greater than 150 microns.

16. The optical device of claim 14, wherein the focusing element is a lens integrated into the substrate, wherein the lens is formed from a same material as the substrate.

17. The optical device of claim 14, further comprising:
a photonic chip, wherein the quarter-wave plate is disposed between the photonic chip and the substrate.

18. The optical device of claim 17, wherein the photonic chip comprises a grating coupler, wherein the focusing element is configured to focus the optical signal onto the grating coupler.

19. The optical device of claim 18, wherein the optical signal propagates in a direction substantially parallel to the first surface between the laser source and the turning mirror and propagates in a direction substantially perpendicular to the first surface between the turning mirror and the grating coupler.

20. The optical device of claim 17, wherein there is no Faraday rotator disposed between the laser source and the turning mirror, wherein the laser source is insensitive to back reflections resulting from the optical signal being reflected by the photonic chip.
